(19) United States
(12) Patent Application Publication
(10) Pub. No.: US 2026/0129259 A1
(43) Pub. Date: May 7, 2026

(54) STITCHING OF VIDEO, AUDIO OR TEXT INFORMATION

(71) Applicant: Derek Christopher Ipaktchian, Topanga, CA (US)

(72) Inventor: Derek Christopher Ipaktchian, Topanga, CA (US)

(21) Appl. No.: 19/376,920

(22) Filed: Nov. 1, 2025

Related U.S. Application Data
(60) Provisional application No. 63/716,181, filed on Nov. 4, 2024.
(60) Provisional application No. 63/886,089, filed on Sep. 23, 2025.

(51) Int. Cl. H04N 21/44; H04N 21/854

(52) U.S. Cl. CPC H04N 21/44016; H04N 21/854

(57) ABSTRACT

Aspects of the disclosure are directed to aggregating multimedia information for presentation. In accordance with one aspect, the disclosure includes displaying a plurality of segments of one or more narratives; and selecting one of the plurality of segments, wherein the one of the plurality of segments include a plurality of submissions and wherein each of the plurality of submissions allows for an inclusion of one or more subsegments. Furthermore, the disclosure includes initiating a narrative by creating a title for the narrative and by recording an initial subsegment for the narrative; saving the narrative onto the stitch platform; and inviting a plurality of guests to view the narrative.

### CLAIM OF PRIORITY UNDER 35 U.S. C. § 119

The present Application for Patent claims priority to Provisional Application No. 63/716,181 entitled “Video Segment Stitching” filed Nov. 4, 2024, and claims priority to Provisional Application No. 63/886,089 entitled “Stitching of Video and/or Audio Segments” filed Sep. 23, 2025, both of the above-mentioned provisional applications are by the same inventor of the present application hereof and are hereby expressly incorporated by reference herein.

### TECHNICAL FIELD

This disclosure relates generally to the field of multimedia and, in particular, to aggregating multimedia information for presentation.

### BACKGROUND

Filming a short narrative has increased in popularity with the advent of social media and smartphones with cameras. Anyone with a smartphone can record a video/audio segment with friends or themselves acting as actors. However, most of such video filming are discrete short video/audio segments with a beginning and an end to a narrative that may be spontaneously created without pre-written text scripts. Thus, there is a need for a platform that allows insertion and/or creation of discrete short video/audio segment(s) to replace corresponding video/audio segment(s) of an existing video/audio content such as a full-length movie, television (TV) show, video clips and/or audio clips.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides aggregating multimedia information for presentation. Accordingly, the present disclosure discloses a method including: displaying a plurality of segments of one or more narratives; and selecting one of the plurality of segments, wherein the one of the plurality of segments include a plurality of submissions and wherein each of the plurality of submissions allows for an inclusion of one or more subsegments.

Another aspect of the disclosure provides a method for implementing storytelling on a stitch platform, the method including: initiating a narrative by creating a title for the narrative and by recording an initial subsegment for the narrative; saving the narrative onto the stitch platform; and inviting a plurality of guests to view the narrative.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example of a homepage of a stitch platform.

FIG. 2 illustrates an example of a top portion of a selected segment page.

FIG. 3 illustrates an example of a bottom portion of the selected segment page.

FIG. 4 illustrates an example view of switching between segments.

FIG. 5 illustrates an example view of a segment page.

FIG. 6 illustrates an example of how to submit subsegment in a submission.

FIG. 7 illustrates an example of a script overlay on a segment page.

FIG. 8 illustrates an example with full page view of one page of a script overlaid on a segment page.

FIG. 9 illustrates an example of a storytelling narrative.

FIG. 10 illustrates an example flow diagram for implementing stitching a narrative.

FIG. 11 illustrates an example flow diagram for implementing stitching a storytelling narrative.

### DETAILED DESCRIPTION

The detailed description set forth below is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In one example, an on-line platform (which may include smart phones or smart tablets) includes features for a subscriber to develop, create, produce and/or edit a video segment of an existing full-length video narrative. In one example, a subscriber is a user who is given access to the on-line platform. The access may be free or there may be an access/usage fee that a would-be user pays to become a subscriber. The term full-length, in one example, denotes that there's a beginning, a middle and an end to the video narrative, although there's no time duration requirement of the video narrative when classifying it as full-length. In one example, the term full-length simply means that there's a complete story plot. In one example, a subscriber is a user of the on-line platform.

In one example, a full-length video narrative is divided into a quantity of video segments. Each video segment includes a text script (or “written narrative or prompt”) for audio and actors for portraying (i.e., acting out) the text script into action. Note that the term “actor” may include human participants, animal participants, animated participants as well as digitally created actors to portray the text script. One skilled in the art would understand that the quantity of video segments may depend on many factors associated with the full-length video narrative, such as but not limited to, the time duration of the full-length video narrative, the story plot, etc. In one example, an artificial intelligence (AI) software program may be used to determine the quantity and/or to divide the full-length video narrative into video segments. Also, in one example, different versions of the same full-length video narrative may have different quantities of video segments.

In one example, a video segment may be divided into more than one sub-segments. In one example, a subscriber may choose one or more video segments of a full-length video narrative to edit and replace the corresponding segment(s) of the full-length video with his edited version. In one example, an edited version does not replace the actors in the corresponding original video segment but may rearrange the order of certain sub-segments or delete one or more sub-segments. The term “original” is meant to denote that the video segment is the one found in the video narrative as originally loaded in the on-line platform without replacement video segments or sub-segments by a subscriber.

In one example, the AI software follows the same criteria to divide a video segment into a quantity of sub-segments as dividing a video narrative into a quantity of video segments. In one example, a subscriber may choose to replace a sub-segment, instead of a full video segment. That is, a sub-segment is the smallest unit that may be replaced. In one example, a sub-segment may be equivalent to a page (e.g., 8 in×11.5 in, double or 1.5 spacing page on a standard font) of the text script.

In one example, prior to choosing a video segment of a full-length narrative to replace, a subscriber may view the database of the on-line platform to determine how many other subscribers have submitted replacement video segments for that particular video segment, with the option of viewing the previously submitted replacement video segments. This will allow the subscriber to decide if he would like to make a replacement video segment on that particular video segment or to choose another video segment to replace.

In one example, a subscriber may pick a video segment of a full-length video narrative and replace it with his own produced video segment. For example, the full-length video narrative is the Hollywood film of Casablanca. One skilled in the art would understand that Casablanca is only an example and that any film may be substituted in this example. For example, Casablanca is divided into a quantity of video segments. For example, subscriber #1 decides to produce his own video segment to replace segment #15 of the Hollywood version of Casablanca. Subscriber #1 decides to make his video segment in color, and to use his wife and himself to play the Ingrid Bergman and Humphrey Bogart roles, respectively. Additionally, subscriber #1 decides to set the background scene in a 1980's discothèque.

For example, subscriber #2 (an unrelated subscriber to subscriber #1) decides to produce his own video segment to replace segment #16 of the Hollywood version of Casablanca. Segment #16 is the video segment after segment #15 that subscriber #1 had replaced. For example, subscriber #2 makes his video segment in color but includes some black and white flashbacks. For example, subscriber #2 uses digitally created actors to portray the Ingrid Bergman and Humphrey Bogart characters. Once subscriber #2 is done with his segment #16, the original Hollywood version of Casablanca is replaced with subscriber #2's segment #16. In this example, subscriber #1's segment #15 and subscriber #2's segment #16 are stitched together with the rest of the segments of the Hollywood version of Casablanca as a new version of the full-length video narrative.

And, in one example, other subscribers may continue to add their own replacement video segments. For example, other subscribers may later edit or replace other video segments which (together with subscriber #1's segment #15 and subscriber #2's segment #16) are stitched together like a big tapestry to generate a new version of the video narrative of Casablanca. In one example, the cohesiveness of the new version of Casablanca is the text script which cannot be changed by any of the subscribers in their replacement segments. Thus, the text script of a video narrative stays the same, but allows each subscriber to use their creativity on how to portray the visual expressions of the characters, the settings, the background scenery, etc. In one example, subscribers may take creative license with the prompt, dialogue or script in creating their interpretation of the video narrative.

In one example, a method for using the on-line platform includes the following steps.
1. Text scripts (e.g., scripts, prompts, descriptions or narratives) are posted on the on-line platform which is accessible to subscribers. The text scripts are divided into a quantity of segments. And, in one example, each segment may be further subdivided into sub-segments. The text scripts may be viewed on the on-line platform or may be downloaded by the subscriber, for example, segment or sub-segment units. In one example, there may be a limit of how many segments (or sub-segments) a subscriber may download at one time. In one example, the entire video narrative may be viewed by the subscriber before deciding on which video segment(s) he would like to replace with his own.
2. The subscriber may title his replacement video segment, list the time duration and a brief description/explanation of his interpretation of his replacement video segment. In one example, the time duration of his replacement video segment does not need to match the time duration of the corresponding original video segment. However, there could be a restriction that a replacement video segment must not exceed or be less than x% of the time duration of the corresponding original video segment. The exact percentage may be determined by the coordinator of the on-line platform and may depend on the video narrative and/or a particular original video segment.
3. In one example, the subscriber can directly replace his replacement video segment with the original video segment in the video narrative and save a version of the video narrative that includes his replacement video segment on the on-line platform. In another example, the subscriber uploads his replacement video segment to the on-line platform and tags it with meta data (e.g., subscriber's information, segment information (title, which segment and which video narrative). In both examples, the subscriber may be asked to confirm that he is the author/creator of the replacement video segment. This is to ensure compliance with copyright laws. In one example, the subscriber may indicate whether his replacement video segment is available for public viewing by all other subscribers or only for limited private viewing such as himself and/or a limited quantity of subscribers.
4. In one example, the coordinator of the on-line platform may determine if a replacement video segment's content may be used as a replacement video segment. In one example, the coordinator may use software programs with artificial intelligence (AI) (“AI software”) for the determination. Other factors for determination may include whether the text script follows the original text script. In one example, a text script threshold must be met by a replacement video segment to qualify as a replacement. For example, the AI software may be used to analyze/compare the words in the replacement video segment against the original text script of the corresponding video segment. In one example, the text script threshold may be a percentage; that is, the quantity of words in the replacement video segment must remain the same as the original text script by a certain percentage to qualify as a replacement video segment. The determination by the AI software may depend on whether the subscriber intends for his generated replacement video segment to be available for public viewing by all other subscribers or only for limited private viewing such as himself and/or a limited quantity of subscribers. In one example, a subscriber may share his created video narrative on his private social media platform.
5. For example, if there are multiple replacement video segments submitted for a particular video segment by multiple subscribers, the coordinator of the on-line platform may determine (for example, using an AI software) which of the submitted replacement video segments will replace a particular video segment of a video narrative that's categorized as available for public viewing.

In one example, different replacement video segments (marked as publicly available) for a particular video narrative are stored on the on-line platform and are available for all subscribers for viewing. In one example, other subscribers may also edit replacement video segments, but the original replacement video segments will continue to be saved on the on-line platform, while edited versions may also be saved as its own distinct versions on the on-line platform.

And, in one example, a subscriber may choose the different replacement video segments from a single video narrative to “stitch” together a replacement video narrative using the different replacement video segments (by other subscribers) and/or some original video segments and/or one or more of his replacement video segments to produce a full-length replacement video narrative of which he is the “creator”.

In one example, different replacement video segments (marked as publicly available) for all video narratives are stored on the on-line platform and are available for all subscribers. And, in one example, a subscriber may choose the different replacement video segments from different video narratives to “stitch” together a new video narrative using the different replacement video segments (by other subscribers) and/or some original video segments from one or more original video narratives and/or one or more of his replacement video segments to produce a full-length new video narrative of which he is the “creator”.

In one example, originally created text scripts by a subscriber may be submitted to the on-line platform. In one example, along with an originally created text script, the subscriber may submit an original full-length video narrative based on the originally created text script. Or, in the alternative, the subscriber may submit one or more video segments of the original full-length video narrative (e.g., in any form-short form or long form) and invite others to add video segments based on his originally created text script. An originally created text script and/or its original full-length video narrative will be treated with the same criteria as any full-length video narrative on the on-line platform, for example, in terms of using AI software to determine replacement video segments.

In one example, the AI software will divide any submitted original full-length video narrative into video segments and/or sub-segments. In one example, the division is based on one or more of the following factors: time duration, content, preset criteria from the subscriber who submitted the originally created text script and/or the original full-length video narrative. In one example, the subscriber who submitted the originally created text script and/or the original full-length video narrative may dictate the quantity of segments, including a maximum quantity or a minimum quantity.

In one example, a subscriber may employ a “chaos mix”. A chaos mix allows the subscriber to use the on-line platform to create a new full-length video narrative by stitching random video segments available on the on-line platform, without the subscriber adding any replacement video segments. In one example, the subscriber may preset some criteria for the chaos mix, such as but not limited to, all video segments must be from a particular genre, all video segments must be from a pre-set list of video narratives, etc.

In one example, a subscriber may use the on-line platform to finish a video narrative of the subscriber's creation (“incomplete video narrative”). For example, a subscriber may create an original incomplete video narrative without an ending and then use the AI software of the on-line platform to create various text scripts and/or video segments to complete one or more versions of the incomplete video narrative. Thus, the completed video narrative would be a collaboration between the subscriber's incomplete video narrative blended with AI software generated video segments.

Although the disclosure presents an example of using the AI software to provide an ending to the incomplete video narrative, one skilled in the art would understand that 1) the incomplete video narrative could be any part of a narrative, such as, the beginning, the middle or the end portions, and that 2) the AI software generated video segments may be used to complete the incomplete video narrative by adding to its content at any part: the beginning, the middle, the end portions, or even mixed portions, such as adding segment(s) at the beginning, the middle and/or the end portions.

In one example, the AI software generates both the text scripts and the video segments (e.g., using digitally created actors) to complete the incomplete video narrative. In another example, the AI software generates only the text scripts for completing the incomplete video narrative while the subscriber takes the text scripts and creates the corresponding video segments. Or, in one example, if the AI software generates only the text scripts for completing the incomplete narrative, the subscriber may invite other subscribers to generate video segment(s) based on the AI software generated the text scripts to complete the incomplete video narrative.

Note that one skilled in the art would understand that although the term “video segment” is used in the present disclosure, the “video segment” may be replaced by an audio segment with only audio and no video content. Similarly, the term “video narrative” may be replaced by “audio narrative” with only audio and no video content. Thus, one skilled in the art would understand that “audio segment(s)” and/or “audio narrative” are also within the scope and spirit of the present disclosure.

Note that one skilled in the art would understand that the coordinator of the on-line platform may be one or more human persons and/or may be software program(s) employing artificial intelligence (AI) to make determinations based on preset criteria.

Note that one skilled in the art would understand that the term “segment” may be interchanged with the noun form of the term “stitch” in the present disclosure to provide the same meaning.

Note that one skilled in the art would understand that the verb form of the term “stitch”, in one example, may mean to generate portion(s) of a narrative by merging segments together.

Note that one skilled in the art would understand that the term “create” and “generate” may be used interchangeably in the present disclosure to provide the same meaning.

Note that one skilled in the art would understand that the pronoun “he” as used in the present disclosure is to be interpreted to include all gender classifications (e.g., male, female, etc.) Note that one skilled in the art would understand that the term “segment” and the term “subsegment” may, in one example, be used interchangeably such that an example of “stitching a subsegment”may in one example, refer to “stitching a segment”.

In one example, a stitch platform is an electronic platform that is available on a computer or an application (e.g., app) operating on a smartphone or on a smart tablet where a user can pick portions of a video or audio story available from the stitch platform database to “stitch” together to create a new story. In another example, the user can also record and/or upload his own originally created storyline or portions thereof to “stitch” together with existing portions of a video or audio story available from the stitch platform database to create a new story.

In one example, a narrative or a segment may be uploaded. In one example, a narrative is a full length story that has a beginning, a middle and an ending A narrative may be a video or it may only contain audio format. A segment is defined as a mini-story. For example, a segment may be considered a scene of a story or a chapter of story or outline, script, summary, etc. In any case, consider a segment as a subset of a narrative. A subsegment is defined as the smallest unit that may be replaced or uploaded in the stitch platform. The unit of a subsegment may be defined by its content, by time, by script length, etc. And, the unit of a subsegment may vary depending on the particular segment or narrative it is derived from. In one example, a subsegment is a subset of a segment which is a subset of a narrative. And, a segment is not bound to have to have a narrative. A segment can be a stand-alone. Similarly, a segment can itself be its own subsegment. And, the quantity of a subsegment for a particular segment can vary depending on that particular segment. Similarly, the quantity of a segment for a narrative can vary depending on that particular narrative.

In one example, once a narrative is broken down into segments and/or a segment is broken down into subsegments, for example, submissions for subsegments are encouraged in the stitch platform. Different users may create their own subsegment submissions for a particular segment and upload it (or record it live straight onto the app where it can be saved as a subsegment). The time durations of each subsegment may differ depending on the particular segment and the particular submission.

In one example, the stitch platform allows the user to view the narrative in its entirely and/or a particular segment (and all its subsegments) in its entirety and repeatedly if desired. Once the user is satisfied, the user can determine if he would like to reenact/reimagine how a subsegment should be. If so, he can 1) record his own subsegment for replacement or 2) pick a subsegment (from a submission of another user) for replacement. And, from this, the user creates his new segment and even a new narrative if he desires to create more than one new segment. The quantity of subsegment(s) and segment(s) a user can upload and/or pick for replacement is only limited by the quantity that is available for that particular segment (or narrative).

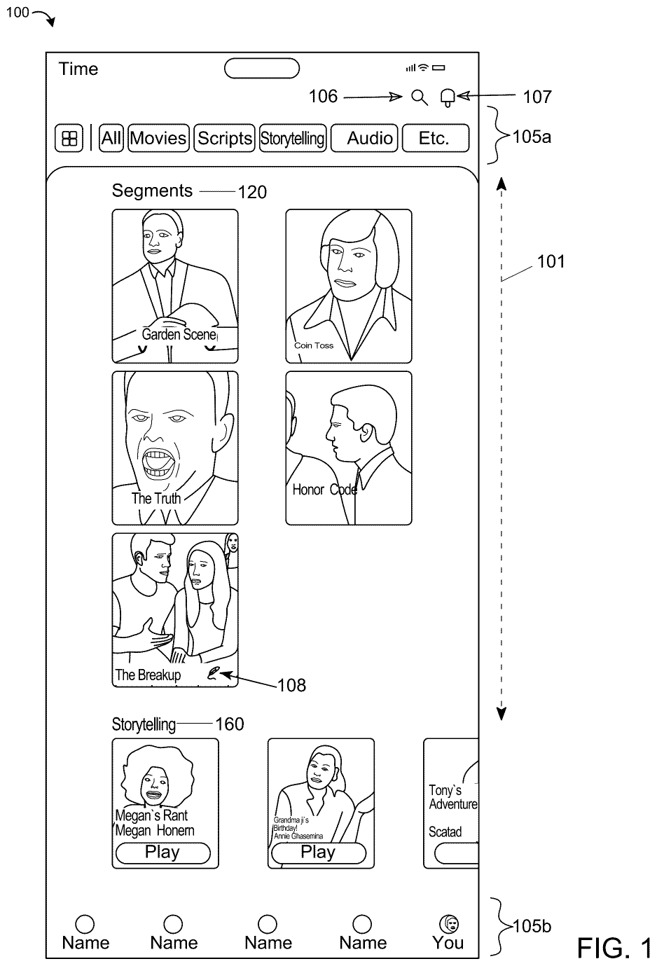

FIG. 1 illustrates an example of a homepage 100 of a stitch platform. In one example, the homepage 100 includes a scrolling bar 101 for scrolling up and down throughout the home page 100. As an example, the homepage 100 shows two main aspects: segments 120 and storytelling 160. In one example, the various segments 120 are shown in the homepage via thumbnail photos. For each segment, one photo is chosen, usually it is an iconic or title scene that the segment's author would like the segment to be identified with. In one example, a random scene/photo from segment may be chosen. In one example, the thumbnail photo may include a title of the segment and a title of the movie from which the segment is derived. Although in FIG. 1 a segment has been illustrated as one of the main aspects, one skilled in the art would understand that the segment may be replaced by a narrative and still be within the spirit and scope of the present disclosure. As shown, each segment may include text depicting, for example, a title. In other examples, an author's name may be included in the text.

Similarly, in the various storytelling 160 are shown in the homepage via thumbnail photos. In one example, the thumbnail photos may include a title of the storytelling and the name of the author. And, for each storytelling, a play button is associated for a user to hit play for its viewing. As shown, the storytelling may include text depicting, for example, a title. In other examples, an author's name may be included in the text.

Additionally, the homepage 100 includes a two part navigation bar 105a, 105b. The top part navigation bar 105a allows a user (e.g., viewer) to view and/or navigate through the contents of the homepage 100. For example, the top part navigation bar 105a includes various tabs such “all”, “movies”, “scripts”, “storytelling”, “audio”, “blank”. In one example, the “blank”tab is a tab that could be customized, for example, by a user.

In one example, the homepage 100 may include a search function via a search icon 106 to allow a user to search for content. Narrowing the search may be accomplished by hitting the search icon 106 and then entering a search criterion in one of the various tabs under the top part navigation bar 105a.

In one example, the homepage 100 includes a notification icon 107 with the function of notifying a user of the appearance of a particular notification condition. Examples of notification conditions include an addition of a movie and/or a segment to the homepage. Examples of notification conditions may also include additions of storytelling content specified by a user. In one example, notification conditions may be created by any user, through the use of a processing engine and artificial intelligence (AI) processing, notification condition(s) may be generated and matched to a user's desired to be notified.

In one example, the bottom part navigation bar 105b includes various tabs of user names. For example, the tab “you” identifies a particular user and that particular user's profile (e.g., photo, user name, saved segments, saved stitches, etc.). In one example, a stitch is defined as a segment or part thereof (such as, a subsegment) a user may have created by adding his own original content. In one example, a subsegment is the smallest unit of original content that can be replaced by a user.

In one example, a red quill icon 108 on a segment indicates that the content of that segment is authored by a user of the homepage and that the segment is not a derived work of a commercial movie, for example, from a movie studio, an independent film company, etc. In one example, to qualify as a segment with a red quill icon 108, the user author must certify that he is the author and that his work is not derived from any commercial movie, commercial/for-profit/non-profit entity. In one example, by uploading a segment with a red quill icon 108, the author is giving permission for any user of the homepage 100 to use any portion of the segment (e.g., any subsegment, any text line, etc. ,) to create another segment for the homepage; that is, to stitch other subsegment(s) to that red quill segment to create a new segment.

Similarly, if the red quill icon 108 is on a full narrative, to indicate that the content of that narrative is authored by a user of the homepage, than, in one example, there is explicit and implied permission by the author of the red quill narrative for another user to stitch one or more segment or subsegment to the narrative to create a new narrative. In one example, a narrative is defined as a full-length story with a beginning, a middle and an ending. A narrative may be divided into multiple segments. And, a segment may be divided into subsegments. A subsegment is the smallest unit of content that may be replaced via stitching.

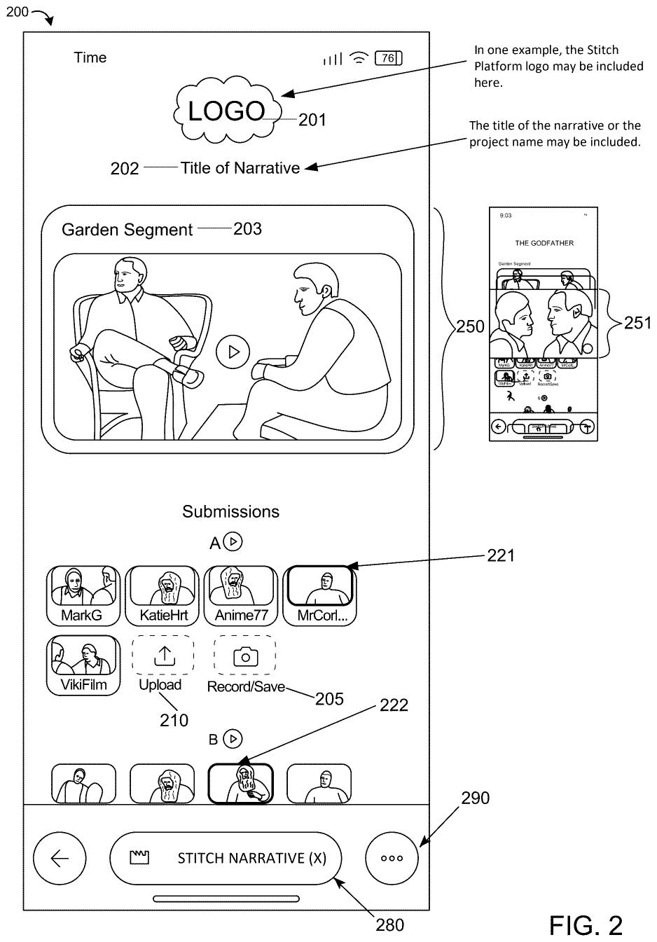

FIG. 2 illustrates an example of a top portion 200 of a selected segment page. As an option, the segment page may include a logo 201, a project title 202, and the segment title 203. In one example, the segment page includes a Stitch Narrative button 280 which allows a user to stitch all selected segments and selected subsegments to create a new narrative. In one example, the user adds his original created segments and/or subsegments to an existing narrative. In one example, the Stitch Narrative button may include an identification of the quantity of segments (or subsegments) being stitched together as indicated by the “X” in (X) on the Stitch Narrative button 280. And, any other untouched segments or subsegments remain as is when the new narrative is formed. That is, start with a narrative in the homepage. A user creates one or more segments/subsegments to replace its corresponding segments/subsegments to result in a new narrative that includes the one or more segments/subsegments created by the user. A record/save button 205 allows a user to record then save a segment/subsegment that a user creates by recording it and then saving it on the homepage. Once the segment/subsegment is saved, it can be uploaded using the upload button 210 so that it becomes available for public viewing and use. In another example, prerecorded segment/subsegments may be uploaded using the upload button 210 into any of the submissions A, B, C, D, etc. of a particular segment. In one example, once a subsegment is saved, it becomes available for other users to view in the stitch platform. In another example, the user must upload the subsegment (after saving it) before the subsegment becomes available for other users to view in the stitch platform.

In one example, the user can also choose/select additional segments/subsegments with segments/subsegments created by other users The user can manually choose these additional segments/subsegments or the user can allow a processing engine using an artificial intelligence (AI) program to choose the most fitting segments/subsegments to finish up the new narrative.

FIG. 2 shows submission A and part of submission B. In one example, submission A includes some first subsegments of the sample segment shown in FIG. 2 (Garden Scene). Under submission A, there are 5 first subsegments submitted by 5 users (e.g., MarkG, KatieHrt, Anime77, MrCorl . . . , VikiFilm). Under submission B, there are some second subsegments submitted by other users.

Shown to the right portion 250 of FIG. 2 is an illustration of a viewing platform 251 a user may use to view, for example, on a smartphone, of the various submissions for the sample segment (e.g., Garden Scene). For example, a user may select under submission A, a first segment by a user Mark G for viewing of the first segment. Once the viewing is done, the user may select another viewing of another first segment by another user, for example, by user Anime77. Once that viewing is done, the user may move on to view a second segment under submission B, and so on. And, the user may view a subsegment more than once or stop viewing it without finishing its entirety. In one example, next to the Stitch Narrative button 280, there is a return to user profile button 290 to allow a user to return to their profile at any time, for example, for viewing their profile information or for editing their profiles.

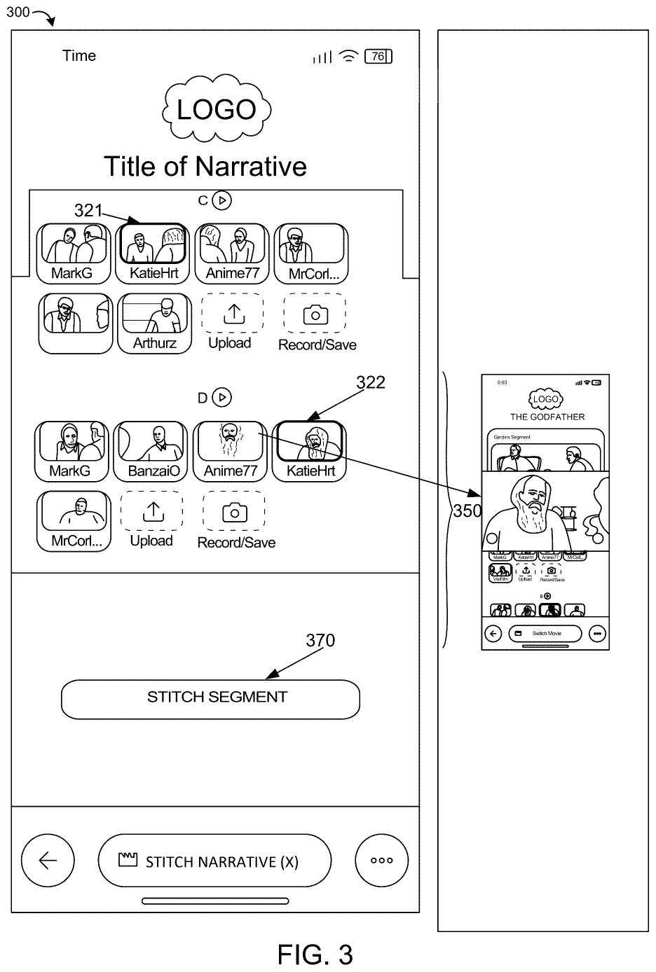

FIG. 3 illustrates an example of a bottom portion 300 of the selected segment page. Shown in FIG. 3 is submission C which includes six third subsegments of the sample segment (Garden Scene) submitted by six users (e.g., MarkG, KatieHrt, Anime77, MrCorl . . . , VikiFilm, ArthurZ). Also shown in FIG. 3 is submission D which includes five fourth subsegments of the sample segment (Garden Scene) submitted by five users (e.g., MarkG, BanzaiO, Anime77, KatieHrt, MrCorl . . . ).

As shown on the right side 350, the user may view subsegments from any of the submissions. For example, the shown in the right side 350, the user is viewing a subsegment from submission D from Anime77 on the user's smartphone. However, as indicated by the darkened border 322, the user ultimately chooses the subsegment by KatieHrt in submission D.

In one example, the ordering of the first subsegment, the second subsegment, the third subsegment, and the fourth subsegment are chronological in following the storyline of the sample segment (Garden Scene). And, a user can view the different submissions under submissions A, B, C, D and pick the subsegment he would like to stitch together. For example, the subsegment(s) picked by the user is illustrated with a darkened border. In FIG. 2, submission A, a darkened border 221 shows that the first subsegment by MrCorl... was picked for stitching. And, the second subsegment with the darkened border 222 was picked for stitching. In FIG. 3, submission C, a darkened border 321 shows that the third subsegment by KatieHrt was picked for stitching. And, the fourth subsegment also by KatieHrt with the darkened border 322 was picked for stitching. In one example, a user is allowed to pick only one subsegment from each submission section.

Once a user has picked all the subsegments for a particular segment that he wants to pick for stitching and/or he has uploaded his subsegment(s) for replacements, the user may use the stitch segment button 370 to stitch all the subsegments he has selected and/or uploaded to create a new replacement segment. If there is any subsegments that he did not pick or did not replace with his own created subsegment, the processing engine of the homepage will employ the AI program to select suitable subsegment(s) to fill in. For example. In the Garden Scene, if the user selects a first subsegment, and uploads a second subsegment but does not select and does upload a third segment or a fourth subsegment, the homepage's AI program will select a suitable third subsegment and a fourth subsegment in submissions C and D, respectively. In one example, the criteria on how the AI program selects may be based on the first and second subsegments. In one example, the time durations of each subsegment for each submission A, B (in FIG. 2) C, D (in FIG. 3) may differ but may have a maximum limit as determined by the stitch platform. This determination of time duration may be based on the particular segment (e.g., Garden Scene).

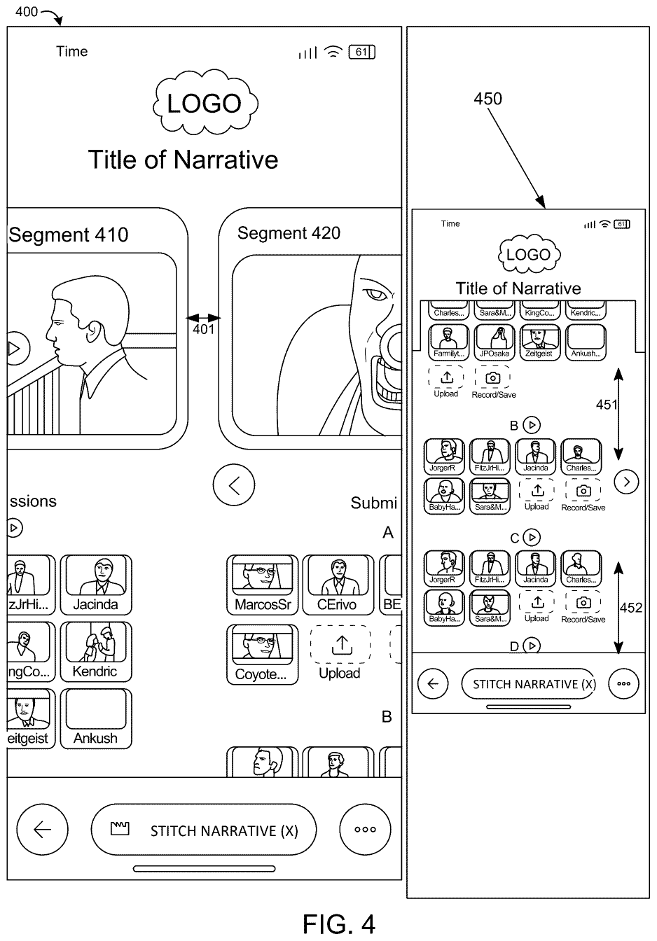

FIG. 4 illustrates an example view 400 of switching between segments. In one example, switching between segments may be accomplished by moving left to right or right to left on the homepage screen as indicated by the arrow 401. Illustrated in example 400 are segment 410 and segment 420 of a narrative. And, below segment 410 are submission(s) of subsegment(s) associated with segment 410 which may be scrolled vertically up and down. Similarly, below segment 420 are submission(s) of subsegment(s) associated with segment 420 which may be scrolled vertically up and down. Although not shown in FIG. 4, a Stitch Segment button can be found when the scrolling has reached the vertical bottom. The right side 450 of FIG. 4 shows the vertical scrolling with arrows 451, 452 to illustrate the submissions B, C, D of subsegments associated with one of the segments of the narrative.

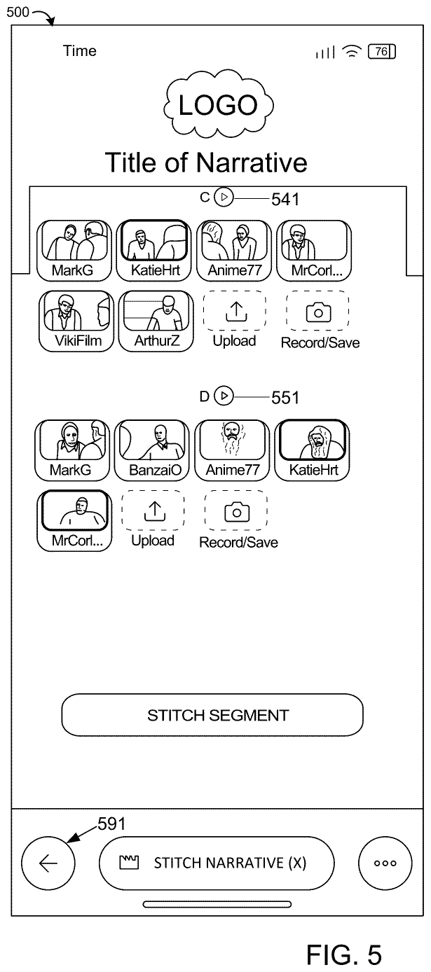

FIG. 5 illustrates an example view 500 of a segment page. Shown in FIG. 5 are subsegments for submissions C and D for the particular segment (Garden Scene). Note that next to submission C, there's a play button 541 which allows the user to play the subsegment in the original segment (or narrative) in that submission. This will allow the user to refresh its memory before picking a subsegment in that submission by another user or to record the user's own subsegment for replacement. Similarly, there's a play button 551 associated with submission D. And, although not shown here, in one example, a play button may be added to each submission. Also shown in FIG. 5 is a return button 591 which allows a user to return to the homepage in FIG. 1.

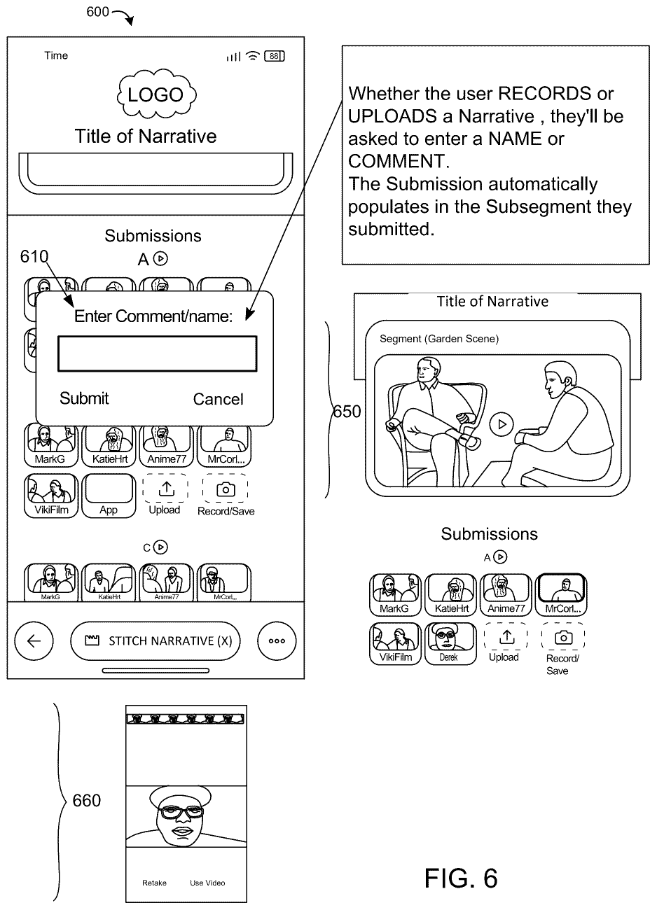

FIG. 6 illustrates an example 600 of how to submit subsegment in a submission. In one example, included in the submission process, the user enters his name and/or comment in an entry box 610 for as part of the submission process. Once submitted, the submission is automatically populated in the submission section

In viewing area 650, the particular segment (e.g., Garden Scene) plays, for example, in the user's smartphone, for the user's viewing. Also visible is the submission choices (e.g., Submission A) which the user may scroll through).

If the user decides that he would rather record his own subsegment, he may use, for example, his smartphone (or another recording device) to create a subsegment. In viewing area 660, the user is recording himself as he acts out the subsegment. For example, he sees his image on his recording device. He can edit his video/audio. He can retake and replay his video/audio until he is satisfied with his recording. The recording/save button 205 (also shown in FIG. 2) may be used to record his subsegment. And once the user is done with his recording, the user can upload his subsegment using the upload button 210 (also shown in FIG. 2).

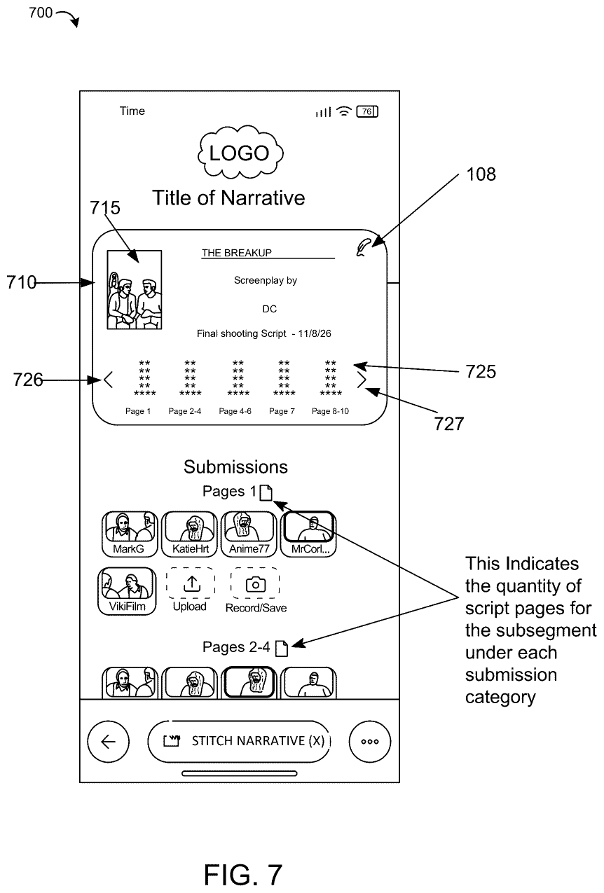

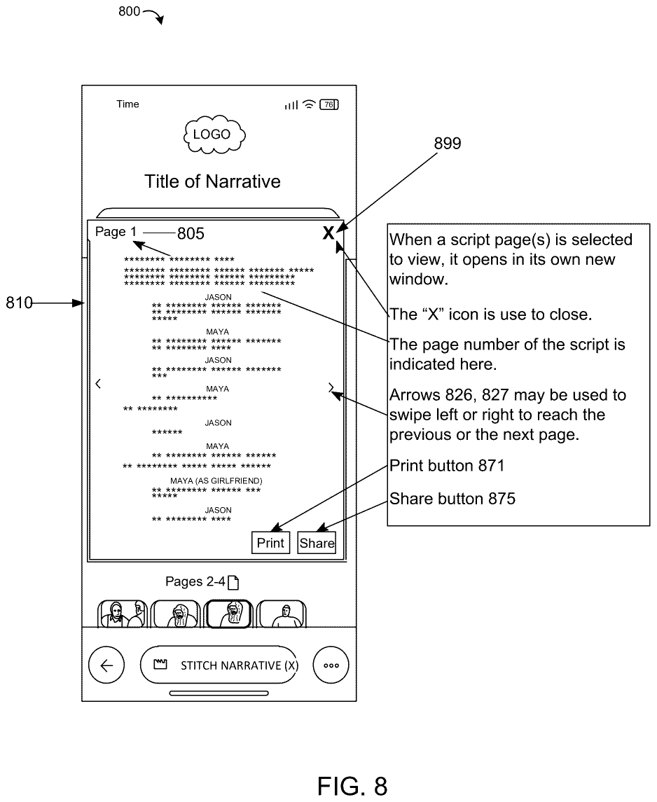

FIG. 7 illustrates an example 700 of a script overlay on a segment page. In the example 700, a script 710 entitled “The Breakup Rehearsal” is uploaded by user DC. In one example, the script 710 is an original script authored by the user. In one example, the user may provide a cover photo 715 for the script. In another example, the user may use the processing engine of the stitch platform to use its artificial intelligence (AI) program to create a photo as a cover photo 715 based on the script.

Shown in section 725 are miniature page representations of the script (e.g., common image format (CIF) of the script pages). Left and Right arrows 726, 727 allow scrolling of the script pages. The red quill icon 108 (also shown in FIG. 1) represents that the script is an original work authored by the user who is/has uploaded the work to the stitch platform.

Once the script is uploaded to the stitch platform, the script will be divided into segments and each segment will be divided into subsegments. Note that if the script is only a segment, then it will only be divided into subsegments. In one example, the user who is the author of the script may divide the script into segments and subsegments. In another example, the user may use the stitch platform's processing engine to use its artificial intelligence (AI) program to divide the script into segments and the segments into subsegments.

In one example, the division into subsegments may be based on pages of the script as indicated by the page number indication under the submissions. In this example, other users are invited to create their own subsegments based on different pages of the script. For example, a user may only desire to create a subsegment of one page and thus he chooses to create a subsegment of page 1. For example, another user may desire to create a subsegment with more pages from the script and may choose to create a subsegment with pages 2-4. Once these other users create, record and save their respective subsegments, they can upload them to the appropriate submission section for others to view and use (e.g., stitch). Thus, the original script uploaded by user DC can invite other users to contribute video/audio subsegments (which may be stitched together to form segments) to his script. And, if there are enough segments, the segments may be stitched together to form a narrative video/audio file.

In one other example, rather than upload video/audio file reenacting the script, another user upload a text script to replace the written script. For example, under the submission with “Page 1”, another user may create his own text script to replace page 1 and upload it to that submission. Similarly, under the submission with “Pages 2-4”, another user may create his own text script to replace pages 2-4 and upload it to that submission. Thus, the original script uploaded by user DC can invite other users to contribute text pages to his original script. In one example, the author of an original narrative may include a No Rewriting option on the script which would prevent other users from rewriting any portion(s) of the script (e.g., Red Quill with an X icon).

FIG. 8 illustrates an example 800 with full page view of one page 810 of a script overlaid on a segment page. Note that the page number 805 (e.g., Page 1) of the script is shown. An X icon 899 allows a use to close the viewing of that page of the script and to return to the script viewing as shown in FIG. 7. Arrows 826, 827 allow scrolling between pages of the script but such scrolling will bring up each page of the script in full page view.

In one example, when appearing in full page view, a print icon 871 is included for a user to print the page of the script. In one example, a share icon 872 is included for a user to share the page of the script (or more than one page of the script or the entire script) with others.

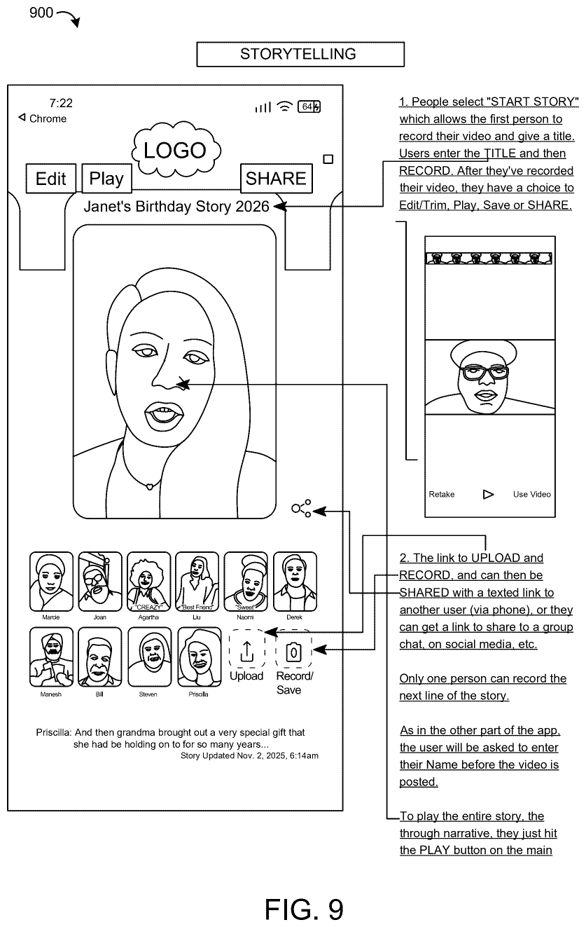

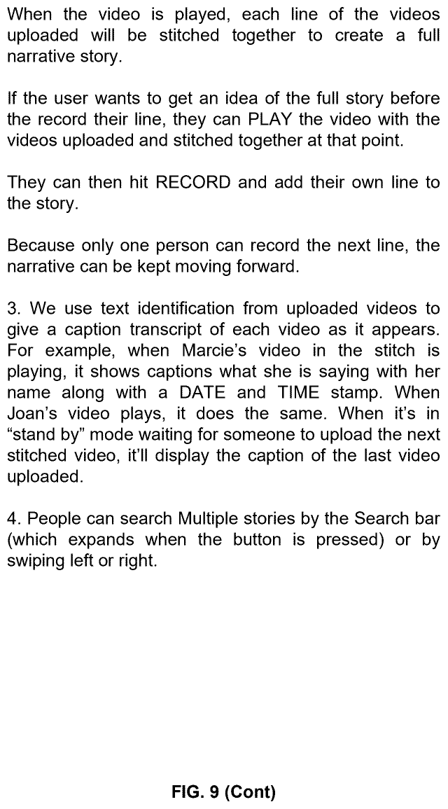

FIG. 9 illustrates an example 900 of a storytelling narrative. In one example, a user may start a narrative by creating a theme. The theme may include, for example, a birthday wish for someone, an anniversary wish, a conversation chain for a specific person or a specific event, a discussion about a particular topic, or just any discussion. One skilled in the art would understand that in the storytelling mode, the theme of the storytelling narrative can include any topic, including a none topic. That is, it could simply be a random discussion for all invited guests to just add their thoughts to the storytelling.

In one example, an initiator starts/initiates a narrative by recording an initial subsegment for the narrative and by creating a title of the narrative. The initial subsegment and the title are saved onto the stitch platform. In one example, associate a theme to the narrative and input the theme of the narrative onto the stitch platform. Next, the initiator uses the stitch platform to invite other guests to add to the narrative. For example, the guests may receive their invitations via emails with a link to access and view any portions of the narrative already recorded on the stitch platform and to use the stitch platform to record their subsegment to add sequentially to the narrative.

In one example, only one guest can view and add to the narrative at a time. In one example, when a guest is adding a subsegment to the narrative, another guest cannot view or add to the narrative and must wait until the narrative is no longer in use by the previous guest. In one example, when the narrative is being viewed or a subsegment related to the narrative is being recorded (which defines that the narrative is in used), a “standby” message may be displayed when another guest requests to access the narrative.

In one example, when a guest records his subsegment, as part of the recording process, the guest is asked to share their identifying information which may include their name, their relationship to the initiator, etc. In one example, the type of identifying information may be dictated by the initiator. That is, the initiator can decide what identifying information is needed from the guest.

And, following each guest's recording, the narrative is increased by the subsegment added by the last guest. In one example, the initiator's subsegment which starts the narrative cannot be modified or deleted by any guest once the narrative is uploaded onto the stitch platform. In one example, once a guest uploads his subsegment to the narrative, that subsegment cannot be modified or deleted from the narrative.

In one example, the narrative includes a close caption text. In one example, each subsegment may dictate the quantity of maximum guests who may add to the narrative. This quantity, for example, may exceed the number of guests invited to participate in the narrative. In one example, a guest may view the narrative without having to record a subsegment.

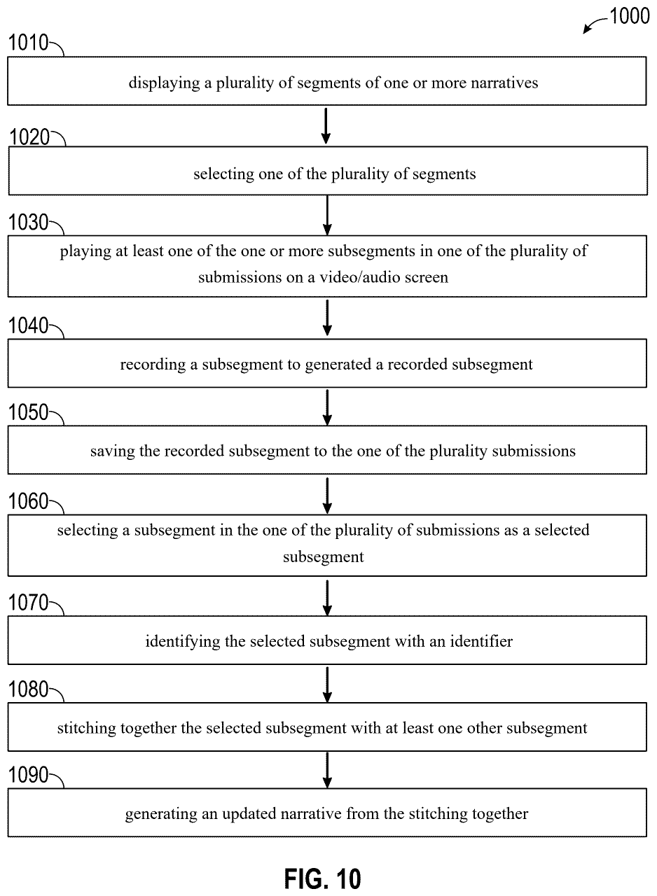

FIG. 10 illustrates an example flow diagram 1000 for implementing stitching a narrative.

In block 1010, display a plurality of segments of one or more narratives.

In block 1020, select one of the plurality of segments.

In block 1030, play at least one of the one or more subsegments in one of the plurality of submissions on a video/audio screen.

In block 1040, record a subsegment to generated a recorded subsegment.

In block 1050, save the recorded subsegment to the one of the plurality submissions.

In block 1060, select a subsegment in the one of the plurality of submissions as a selected subsegment.

In block 1070, identify the selected subsegment with an identifier.

In block 1080, stitch together the selected subsegment with at least one other subsegment.

In block 1090, generate an updated narrative from the stitching together. In one example, an updated narrative is the original or initial narrative that has been modified with, for example, one or more additional subsegments. In one example, an updated narrative is the original or initial narrative with any modification added to it.

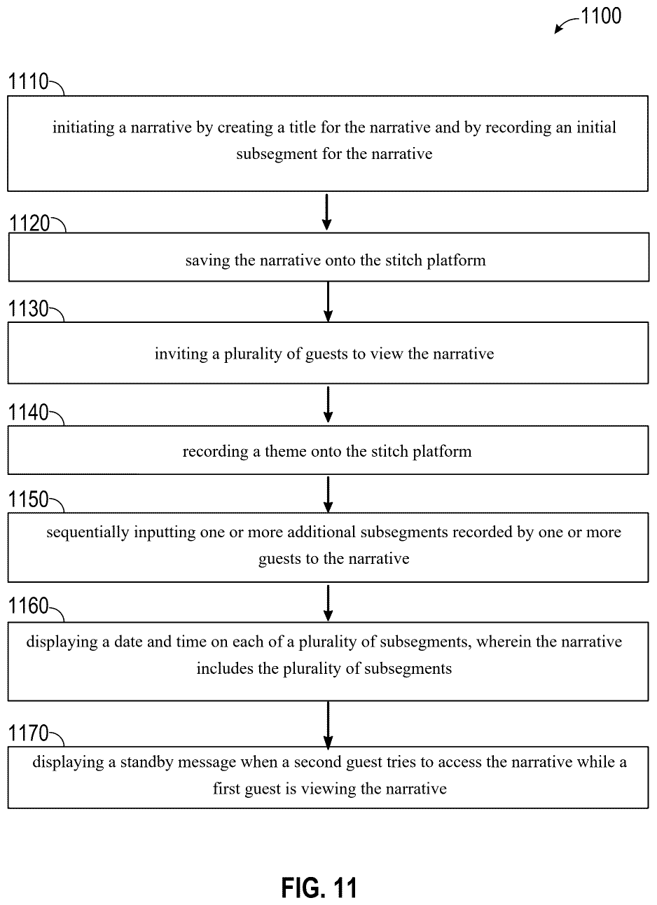

FIG. 11 illustrates an example flow diagram 1100 for implementing stitching a storytelling narrative.

In block 1110, initiates a narrative by creating a title for the narrative and by recording an initial subsegment for the narrative.

In block 1120, save the narrative onto the stitch platform.

In block 1130, invite a plurality of guests to view the narrative.

In block 1140, record a theme onto the stitch platform.

In block 1150, sequentially input one or more additional subsegments recorded by one or more guests to the narrative.

In block 1160, display a date and time on each of a plurality of subsegments, wherein the narrative includes the plurality of subsegments.

In block 1170, display a standby message when a second guest tries to access the narrative while a first guest is viewing the narrative.

In one example, the disclosure discloses a method including: displaying a plurality of segments of one or more narratives; and selecting one of the plurality of segments, wherein the one of the plurality of segments include a plurality of submissions and wherein each of the plurality of submissions allows for an inclusion of one or more subsegments.

In one example, the one of the plurality of segments is in a video format. In one example, the one of the plurality of segments is in an audio format. In one example, the one of the plurality of segments is in a text format. In one example, the one of the plurality of segments is a text script of a narrative.

In one example, the method further includes playing at least one of the one or more subsegments in one of the plurality of submissions on a video/audio screen. In one example, the method further includes: recording a subsegment to generated a recorded subsegment; and saving the recorded subsegment to the one of the plurality submissions. In one example, the method further includes selecting a subsegment in the one of the plurality of submissions as a selected subsegment; and identifying the selected subsegment with an identifier.

In one example, the identifier is a border placed around a visual representation of the selected subsegment. In one example, the method further includes stitching together the selected subsegment with at least one other subsegment, wherein the at least one other subsegment is not in the same one of the plurality of submissions of the selected subsegment. In one example, the method further includes generating an updated narrative from the stitching together.

In one example, the at least one other subsegment is selected by an artificial intelligence program. In one example, one of the at least one other subsegment is the recorded subsegment.

In one example, the method further includes recording a first subsegment and a second subsegment, wherein the first subsegment is from a first of the plurality of submissions and the second subsegment is from a second of the plurality of submissions, to generate a first recorded subsegment and a second recorded subsegment; saving the first recorded subsegment to the first of the plurality submissions; and saving the second recorded subsegment to the second of the plurality submissions.

In one example, the method further includes stitching together the first recorded subsegment, the second recorded subsegment with at least one other subsegment to generate an updated narrative, wherein the at least one other subsegment is not in the first of the plurality of submissions, and wherein the at least one other subsegment is not in the second of the plurality of submissions.

In one example, the disclosure discloses a method for implementing storytelling on a stitch platform, the method including: initiating a narrative by creating a title for the narrative and by recording an initial subsegment for the narrative; saving the narrative onto the stitch platform; and inviting a plurality of guests to view the narrative.

In one example, the method further includes recording a theme onto the stitch platform, wherein the theme is associated with the narrative. In one example, the method further includes sequentially inputting one or more additional subsegments recorded by one or more guests to the narrative. In one example, the method further includes displaying a date and time on each of a plurality of subsegments, wherein the narrative includes the plurality of subsegments. In one example, the method further includes displaying a standby message when a second guest tries to access the narrative while a first guest is viewing the narrative.

In one aspect, one or more of the steps for providing aggregating multimedia information for presentation in FIGS. 10 and 11 may be executed by one or more processors which may include hardware, software, firmware, etc. The one or more processors, for example, may be used to execute software or firmware needed to perform the steps in the flow diagrams of FIGS. 10 and 11. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration. ” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more. ” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S. C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
displaying a plurality of segments of one or more narratives; and
selecting one of the plurality of segments, wherein the one of the plurality of segments include a plurality of submissions and wherein each of the plurality of submissions allows for an inclusion of one or more subsegments.

2. The method of claim 1, wherein the one of the plurality of segments is in a video format.

3. The method of claim 1, wherein the one of the plurality of segments is in an audio format.

4. The method of claim 1, wherein the one of the plurality of segments is in a text format.

5. The method of claim 1, wherein the one of the plurality of segments is a text script of a narrative.

6. The method of claim 1, further comprising playing at least one of the one or more subsegments in one of the plurality of submissions on a video/audio screen.

7. The method of claim 6, further comprising:
recording a subsegment to generated a recorded subsegment; and
saving the recorded subsegment to the one of the plurality submissions.

8. The method of claim 6, further comprising
selecting a subsegment in the one of the plurality of submissions as a selected subsegment; and
identifying the selected subsegment with an identifier.

9. The method of claim 8, wherein the identifier is a border placed around a visual representation of the selected subsegment.

10. The method of claim 8, further comprising stitching together the selected subsegment with at least one other subsegment, wherein the at least one other subsegment is not in the same one of the plurality of submissions of the selected subsegment.

11. The method of claim 10, further comprising generating an updated narrative from the stitching together.

12. The method of claim 11, wherein the at least one other subsegment is selected by an artificial intelligence program.

13. The method of claim 11, wherein one of the at least one other subsegment is the recorded subsegment.

14. The method of claim 6, further comprising:
recording a first subsegment and a second subsegment, wherein the first subsegment is from a first of the plurality of submissions and the second subsegment is from a second of the plurality of submissions, to generate a first recorded subsegment and a second recorded subsegment;
saving the first recorded subsegment to the first of the plurality submissions; and
saving the second recorded subsegment to the second of the plurality submissions.

15. The method of claim 14, further comprising stitching together the first recorded subsegment, the second recorded subsegment with at least one other subsegment to generate an updated narrative, wherein the at least one other subsegment is not in the first of the plurality of submissions, and wherein the at least one other subsegment is not in the second of the plurality of submissions.

16. A method for implementing storytelling on a stitch platform, the method comprising:
initiating a narrative by creating a title for the narrative and by recording an initial subsegment for the narrative;
saving the narrative onto the stitch platform; and
inviting a plurality of guests to view the narrative.

17. The method of claim 16, further comprising recording a theme onto the stitch platform, wherein the theme is associated with the narrative.

18. The method of claim 17, further comprising sequentially inputting one or more additional subsegments recorded by one or more guests to the narrative.

19. The method of claim 18, further comprising displaying a date and time on each of a plurality of subsegments, wherein the narrative includes the plurality of subsegments.

20. The method of claim 19, further comprising displaying a standby message when a second guest tries to access the narrative while a first guest is viewing the narrative.
